(19) United States
(12) Patent Application Publication
(10) Pub. No.: US 2008/0299315 A1
(43) Pub. Date: Dec. 4, 2008

(54) METHOD OF MANUFACTURING DISPLAY PANEL

(75) Inventors: Teruhiko IWASE, Nagoya-city (JP); Toshio Koura, Takahama-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/129,162

(22) Filed: May 29, 2008

(30) Foreign Application Priority Data
May 29, 2007 (JP) 2007-141565

(51) Int. Cl. B05D 1/36

(52) U.S. Cl. 427/265

(57) ABSTRACT

In a method of manufacturing a display panel that includes a base and a printed layer printed on the base by inkjet printing, a color UV curable ink is deposited on a predetermined portion of the base for forming a color printed portion of the printed layer, and a transparent UV curable ink is deposited in at least one of a first depression provided by the color printed portion on a surface of the base and a second depression formed on a surface of the color printed portion for forming a transparent printed portion.

### CROSS REFERENCE TO RELATED APPLICATION

This application is based on Japanese Patent Application No. 2007-141565 filed on May 29, 2007, the disclosure of which is incorporated herein by reference.

### FIELD OF THE INVENTION

The present invention relates to a method of manufacturing a display panel for a display device such as an instrument for a vehicle.

### BACKGROUND OF THE INVENTION

In a vehicle, for example, a display device such as an instrument is installed in front of a driver's seat. The display device is generally constructed of a display panel, a light source arranged on a rear side of the display panel, and the like. The display panel has design portions including a scale, characters, indicators and the like. The design portions are provided by a printed layer formed on a base plate of the display panel. Such a display device is, for example, described in Japanese Unexamined Patent Application Publications No. 2004-286459 (U.S. Pat. No. 6,856,478), No. 2005-321343, No. 2006-214906, and No. 2006-221044.

In such a display panel, the scale, the characters and the like as the design portions are provided by transparent portions that allow light to pass through, and a background portion other than the scale, characters and the like is provided by an opaque portion that does not allow light to pass through. Thus, when the display panel is lit by a light source, for example in night time, the transparent portions can be illuminated.

The above display panel is, for example, formed by screen printing the opaque portion on a surface of a resinous transparent base plate, such as a polycarbonate plate. That is, the opaque portion is formed as a matted and covered image portion. After the screen printing, the display panel is processed to be installed in a display device. For example, the display panel is cut into a predetermined shape, and/or holes are formed on the display panel such as by punching.

With regard to the screen printing, a screen on which a printing image is made based on print data is prepared, and then ink is deposited on a base plate through the screen. As the ink, for example, a solvent dry-type ink that is dried by solvent, a thermosetting-type ink that is cured by heat, or the like are used. The screen printing has an advantage that the opaque portion is formed at a time to have the sufficient print density. However, the screen printing is generally a single-color printing. To form the design portions such as the characters, it is necessary to deposit inks having different colors in layers. Therefore, the number of processing steps and a processing time increase. Also, because accuracy of printing positions and resolution are generally low, a printing design is likely to be restricted.

With regard to display devices for vehicles, design of the display panels are different depending on vehicle model, capacity grade and the like. That is, printing contents to be formed on the display panel are different depending the type of the vehicles. To form the display panels of the display devices for the vehicles by screen printing, various operations, such as replacement of the screens and inks, setting of printing conditions and the like, are required for each of types of the display panels. In general, the screen printing is one of high-volume manufacturing methods.

In contrast, on-demand printing methods in which images are directly printed on base plates based on print data without using screens have been developed. Inkjet printing is generally known as one of the on-demand printing methods. As described in Japanese Unexamined Patent Application Publications No. 2004-16916 and No. 2004-286459, inkjet printing is performed by ejecting drops of ink from inkjet heads, which are electronically controlled. Because an inkjet printing device generally has a simple mechanism, an initial cost is generally low. Also, high image resolution is achieved by the inkjet printing device. As such, the inkjet printing device has been come into wide use, such as in the field of office automation printers.

In a case where the inkjet printing is employed to from the printed layer of the display panel, there are some drawbacks. For example, because optical transparency and thermal resistance are required in the display panel for the vehicles, plates that are made of polycarbonate or polyethylene terephthalate are used as base plates. If a water soluble ink is deposited on a surface of a polycarbonate base plate or polyethylene terephthalate base plate by inkjet printing, the ink is rejected on the surface. Also, if the solvent-type ink is deposited to the surface of such base plates by inkjet printing, ink droplets are likely to be condensed before being dried, and the base plates are likely to be melted and deformed.

Therefore, as described in the publications No. 2005-321343, No. 2006-221044, No. 2006-214906, a method of manufacturing a display panel by inkjet printing using ultraviolet curable ink (hereinafter, UV curable ink) is known. In the described method, the printed layer is formed on a resinous base plate by inkjet printing using the UV curable ink. In the inkjet printing using the UV curable ink, because the ink does not penetrate into the base plate, the deposited ink will be spread on the base plate if it takes time to cure the deposited ink. In this case, it is difficult to maintain the predetermined image. Therefore, it is necessary to cure the ink in a few seconds after the ink is deposited on the base plate. Further, it is necessary to overprint the ink in layers to form a portion having a dark color such as the opaque portion.

In the inkjet printing, generally the UV curable ink is dotted in lines, and thus, printed lines, which are regularly parallel and adjacent to each other, are formed. Further, to form the opaque portions to be mat or to be impenetrable by inkjet printing, it is necessary to form the printed lines in layers. As a result, the surface of the printed layer have rounded ridges and an appearance of the display panel will be deteriorated due to unevenness, such as projections and depressions, of the surface of the printed layer. Further, since the UV curable ink is cured immediately after being deposited on the panel, the projections and depressions are likely to be more visible.

In addition, if the thickness of the printed layer is different between the opaque portion and the transparent portions, the projections and depressions of the surface of the printed layer are visible depending on an external light condition, such as when the external light is emitted diagonally to the surface of the display panel.

### SUMMARY OF THE INVENTION

The present invention is made in view of the foregoing matter, and it is an object of the present invention to provide a method of manufacturing a display panel, capable of reducing projections and depressions of a surface of a printed layer and enhancing a design.

According to an aspect of the present invention, a method of manufacturing a display panel includes forming a color printed portion and forming a transparent printed portion. The display panel has a resinous base and a printed layer printed on the base by inkjet printing using UV curable ink, which contains UV monomer capable of being polymerized by an ultraviolet light. The forming of the color printed portion is performed by depositing a color UV curable ink on a predetermined portion of the base. The forming of the transparent printed portion is performed by depositing a transparent UV curable ink in at least one of a first depression provided by the color printed portion on a surface of the base and a second depression formed on a surface of the color printed portion. Thus, the printed layer including the color printed portion and the transparent printed portion is formed on the surface of the base.

Accordingly, the display panel including the base and the printed layer is produced. When the color UV curable ink is deposited on the base by inkjet printing, projections and depressions are generated between a region where the color printed portion is formed and a region where the color printed portion is not formed on the base, and/or between a region where the thickness of the color printed portion is large and a region where the thickness of the color printed portion is small. That is, the first depression corresponds to the region where the color printed portion is not formed on the base, and the second depression corresponds to the portion where the thickness of the color printed portion is smaller than the other portion, such as creases provided between rounded ridges of the color printed portion that is formed in a regular linear pattern. Since the transparent UV curable ink is deposited in at least one of the first depression and the second depression, the projections and depressions of a surface of the printed layer are reduced. That is, the printed layer has a generally smooth surface. Therefore, an appearance of the display panel enhances. Thus, the display panel provides an enhanced design.

### BRIEF DESCRIPTION OF THE DRAWINGS

Other objects, features and advantages of the present invention will become more apparent from the following detailed description made with reference to the accompanying drawings, in which like parts are designated by like reference numbers and in which:

FIG. 1 is a front view of a display panel according to a first embodiment of the present invention;

FIG. 2A is an enlarged cross-sectional view of a portion of the display panel before an overcoat layer is formed according to the first embodiment;

FIG. 2B is an enlarged cross-sectional view of the portion of the display panel after the overcoat layer is formed according to the first embodiment;

FIG. 3 is a schematic view of an inkjet printing device according to the first embodiment;

FIG. 4 is an enlarged cross-sectional view of a portion of the display panel, for showing an example in which color ink is partially included in a transparent printed portion, according to the first embodiment;

FIG. 5A is a plan view of a printed layer formed on a surface of a display panel by inkjet printing;

FIG. 5B is a schematic cross-sectional view of the printed layer shown in FIG. 5A;

FIG. 6A is a plan view of a printed layer formed on a surface of the display panel by inkjet printing, for showing an example of a printing pattern of the transparent printed portion, according to the first embodiment;

FIG. 6B is a plan view of a printed layer formed on a surface of the display panel by inkjet printing, for showing another example of the printing pattern of the transparent printed portion, according to the first embodiment;

FIG. 7 is a plan view of an overcoat layer formed by discontinuously depositing transparent UV curable ink by inkjet printing according to a second embodiment of the present invention;

FIG. 8 is a partial enlarged view of FIG. 7;

FIG. 9A is a cross-sectional view of a portion of the display panel according to the second embodiment of the present invention;

FIG. 9B is a cross-sectional view of a portion of the display panel other than the portion shown in FIG. 9A, according to the second embodiment of the present invention;

FIG. 10A is a cross-sectional view of a portion of a display panel before an overcoat layer is formed according to a comparative example; and

FIG. 10B is a cross-sectional view of the portion of the display panel after the overcoat layer is formed according to the comparative example.

### DETAILED DESCRIPTION OF EMBODIMENTS

In embodiments of the resent invention, a display panel having a resinous base plate (resinous base) and a printed layer printed on at least a portion of the base plate by inkjet printing using UV curable ink is produced. The inkjet printing includes a step of forming a color printed portion and a step of forming a transparent printed portion. In the step of forming the color printed portion, color UV curable ink is deposited on a predetermined portion of a surface of the base plate and is cured by radiation of ultraviolet light (hereinafter, UV light). In the step of forming the transparent printed portion, transparent UV curable ink is deposited to at least one of a depression (e.g., first depression) provided between the color printed portion and the surface of the base plate and a depression (e.g., second depression) provided on the surface of the color printed portion.

When the color printed portion is formed on the base plate by inkjet printing, projections and depressions are generated. For example, the projections and depressions are caused between a region where the color printed portion is formed and a region where the color printed portion is not formed on the surface of the base plate. As another example, the projections and depressions are caused between a region where the thickness of the color printed portion is large and a region where the thickness of the color printed portion is small. In the step of forming the transparent color portion, the transparent printed portion is formed by depositing the transparent UV curable ink in such depressions and curing the deposited transparent UV curable ink.

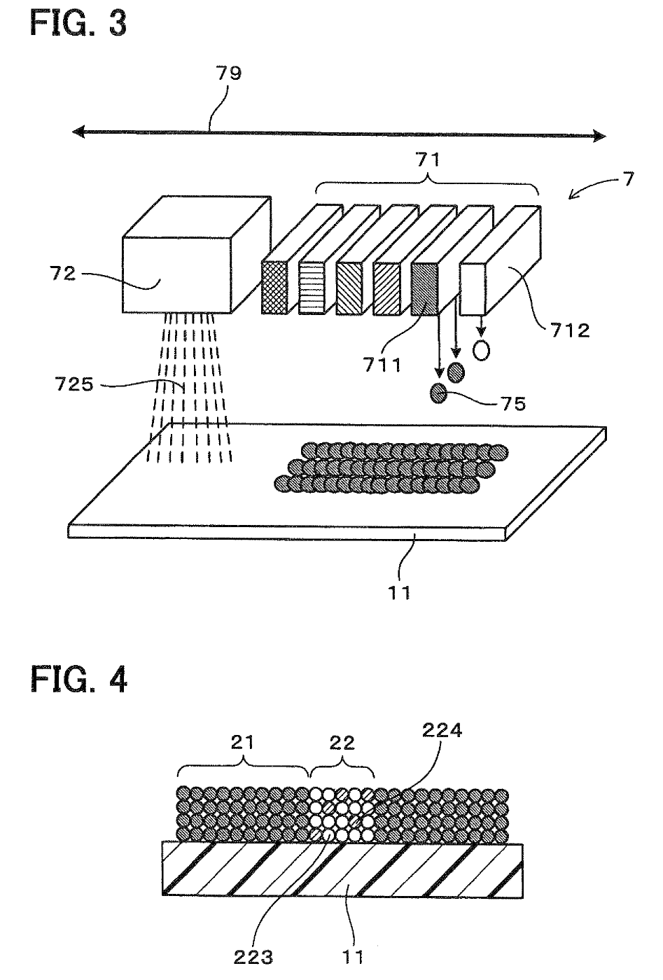

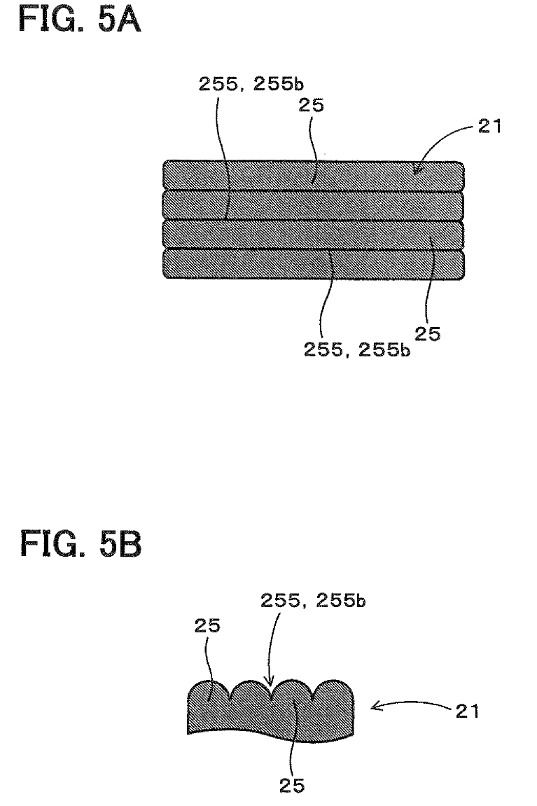

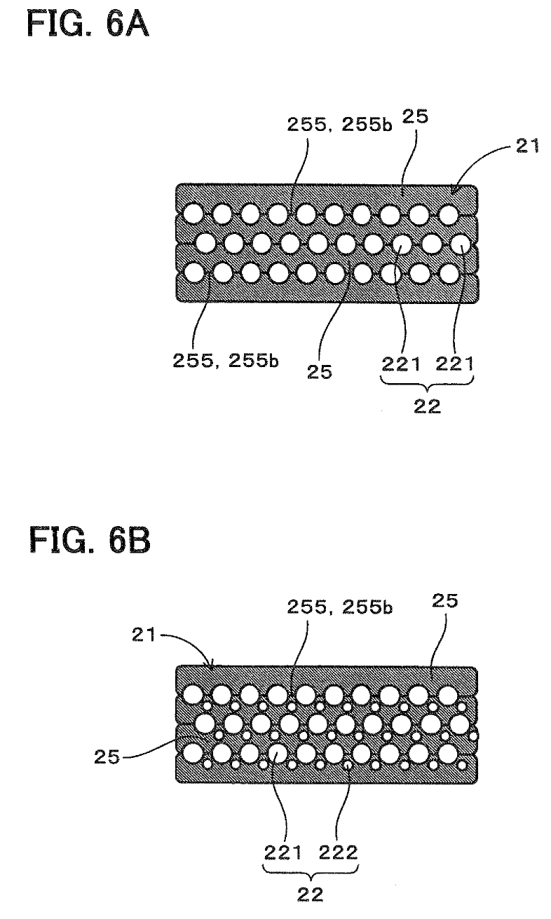

To form the color printed portion by an inkjet printing device 7, as shown in FIG. 3, a UV curable ink 75 is ejected toward a base plate 11 by a nozzle 71 that moves in a direction 79 (hereinafter, nozzle-travel direction). Therefore, as shown in FIG. 5A, a color printed portion 21 is printed in a linear pattern 25 extending in the nozzle-travel direction 79. The color printed portion 21 printed in the linear pattern 25 has ridges, as shown in FIG. 5B. That is, depressions 255 can be formed between the ridges, that is, by creases between the ridges. Thus, a transparent printed portion 22 can be formed in the depressions 255, as shown in FIGS. 6A and 6B.

If the transparent UV curable ink is continuously sprayed, a liner pattern is newly formed. That is, the transparent printed portion 22 is formed in the liner pattern, and the projections and depressions are formed by the transparent printed portion 22 again. To restrict the projections and depressions due to the transparent printed portion 22, a transparent UV curable ink 221 can be discontinuously deposited and cured thereon as shown in FIG. 6A. That is, the transparent printed portion 22 is formed in a nonlinear pattern, that is, in a discontinuous linear pattern in the nozzle-travel direction 79. Accordingly, the depressions 255, such as the creases provided between the ridges of the color printed portion 21, are alleviated. As another example, the transparent printed portion 22 can be formed by depositing the transparent UV curable ink 221 in the discontinuous manner and a transparent UV curable ink 222 between the deposited transparent ink 221, as shown in FIG. 6B. In this case, the projections and depressions are further reduced.

In the step of forming the transparent printed portion, for example, the transparent printed portion 22 is formed such that a height difference between the transparent printed portion 22 and the color printed portion 21 is equal to or less than 30 μm.

If the height difference between the transparent printed portion and the color printed portion is greater than 30 μm, that is, if the surface of the printed layer is largely uneven, projections and depressions of the surface of the printed layer 2 are conspicuously visible, depending on a condition of an external light. Further, if a transparent overcoat layer 3 is formed over the printed layer having such large projections and depressions, it is difficult to sufficiently enter the ink in the depressions. Accordingly, the gloss and brightness of the overcoat layer 3 are uneven. As a result, the design and appearance of the display panel will be deteriorated.

In the case where the transparent overcoat layer 3 for matting is formed over the printed layer 2 having a substantially smooth surface, a matting effect of the overcoat layer 3 improves. For example, the overcoat layer 3 is formed by screen printing. In the case where the overcoat layer 3 is formed over the printed layer 2 having the substantially smooth surface, a surface of the overcoat layer 3 is formed substantially evenly. Thus, the design and appearance of the display panel enhance. In the case of forming the overcoat layer 3 by screen printing, urethane beads and the like in micron size can be contained in the overcoat layer 3.

Alternatively, the transparent overcoat layer 3 can be formed by inkjet printing. In the case of forming the transparent overcoat layer 3 by inkjet printing, a transparent UV curable ink is deposited in a discontinuous manner on the printed layer. In this case, since a regular arrangement of the linear pattern of the printed layer, which is caused by inkjet printing, is disrupted or interrupted, the gloss of the surface can controlled.

In the case of forming the printed layer by inkjet printing, since the UV curable ink is ejected by the nozzle 71 that linearly moves in the nozzle-travel direction 79, the printed layer is formed in the linear pattern extending in the nozzle-travel direction 79, irrespective of the color printed portion and the transparent printed portion. Therefore, the surface of the printed layer have regular ridges. If the light is emitted to the surface of the printed layer having the regular ridges in a predetermined direction, interference of light is generated on the surface of the printed layer, and hence the appearance of the display panel deteriorates.

On the other hand, in the case of depositing a transparent UV curable ink 30 for the overcoat layer 3 in the discontinuous manner, ink particles are arranged discontinuous or less continuous with respect to the nozzle-travel direction 79. Thus, the regular arrangement of the surface of the printed layer 2 is interrupted. As such, the gloss of the surface is controlled.

In the embodiments, the UV curable ink can includes various substances, such as pigments having predetermined colors, UV monomer, initiator, disperser and the like. For example, mono-functional monomer, multi-functional monomer or the like can be employed as the UV monomer. The UV curable ink can be cured by polymerization of the UV monomer by the radiation of the UV light.

The resinous base plate has transparency, and the printed layer includes a transparent portion that allows a visible-light to pass through and an opaque portion that does not allow the visible-light to pass through. In the display panel, the transparent portion is illuminated by emitting the light from the rear side.

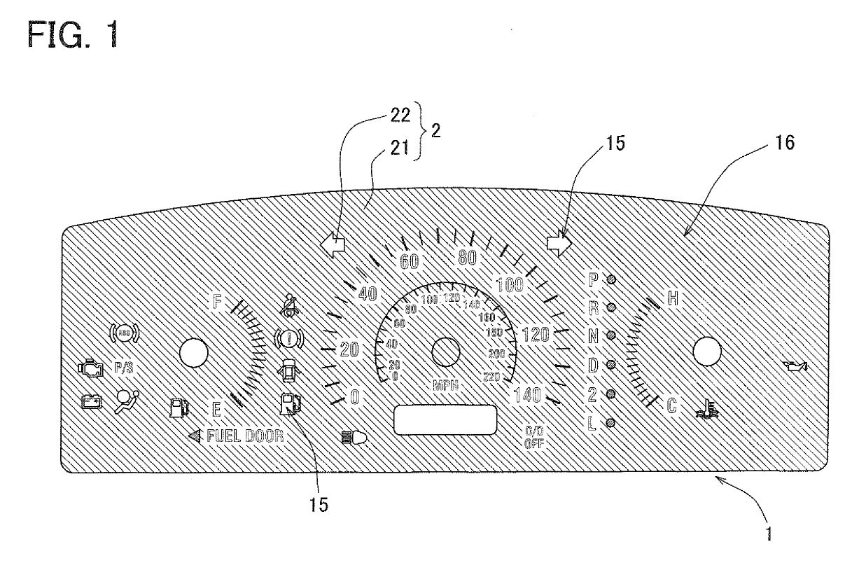

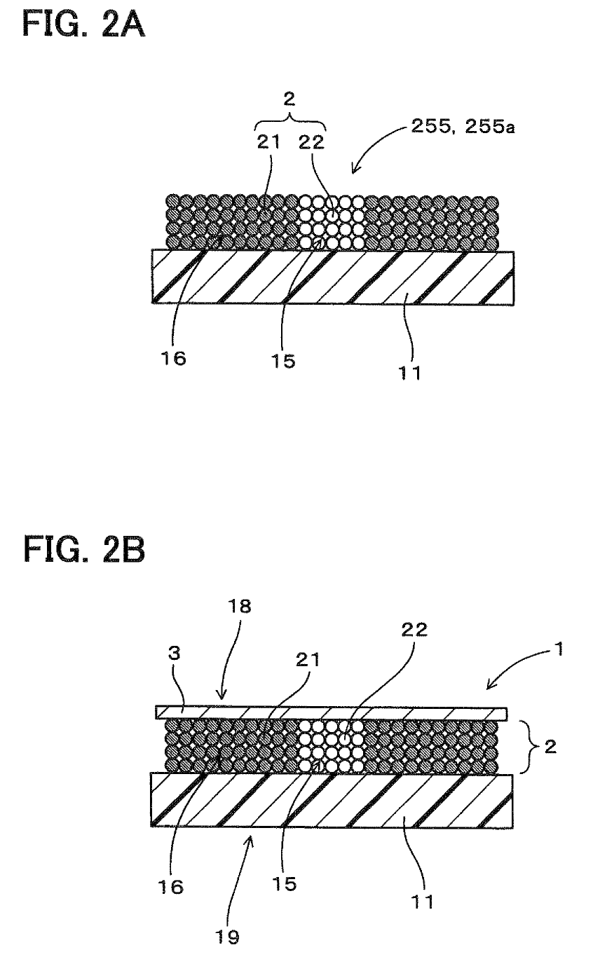

The display panel is for example used as a back-light type display panel of an instrument for a vehicle, as shown in FIGS. 1 and 2B. As shown in FIG. 1, a display panel 1 has scales, characters, indicators and the like. The scales, the characters and the like are provided by the transparent portion 15. The transparent portion 15 is illuminated by a light emitted from a light source provided on a rear side 19 of the display panel 1. In the base plate 11, the color printed portion 21 is formed by color UV curable ink (e.g., black) in an area other than the transparent portion 15. The color printed portion 21 forms the opaque portion 16 as a background.

For example, the transparent portion 15 and the opaque portion 16 are formed by adjusting the color, thickness, the print density of the printed layer 2 (color printed portion 21).

The transparent portion 15 is formed by reducing the thickness of the printed layer 2, reducing the print density, and/or reducing the color density. Alternatively, the transparent portion 15 can be provided without forming the printed layer in the area corresponding to the transparent portion 15. On the other hand, the opaque portion 16 is, for example, formed by increasing the thickness of a design film, and/or printing the black UV curable ink in layers as the color printed portion 21.

As the base plate, for example, a transparent plate made of a thermoplastic resin such as a polycarbonate, polyethylene terephthalate (PET) or the like, can be used. Preferably, the base plate is made of polycarbonate. In this case, the display panel is more effectively used in the back-light type instrument. That is, because the polycarbonate plate have sufficient transparency, the brightness of the light source is hardly reduced. Therefore, the transparent portion 15 are clearly displayed. Further, the polycarbonate plate achieves sufficient adhesion with the UV curable ink.

Hereinafter, the embodiments of the present invention will be described more in detail as a first embodiment and a second embodiment.

### First Embodiment

Referring to FIGS. 1 to 3, a display panel 1 of the present embodiment is exemplarily employed as a meter panel, that is, a dial board of a vehicular instrument.

As shown in FIGS. 1 and 2B, the display panel 1 has a resinous base plate (resinous base) 11 and a printed layer 2 printed on a surface of the resinous base plate 11 by inkjet printing using UV curable ink. In the inkjet printing, the UV curable ink is deposited on the surface of the resinous base plate 11 and cured thereon.

The printed layer 2 includes a color printed portion (e.g., color printed layer) 21 and a transparent printed portion (e.g., transparent printed layer) 22. FIG. 2B shows a boundary of the color printed portion 21 and the transparent printed portion 22.

The resinous base plate 11 is, for example, made of a resin material having transparency, such as polycarbonate. The display panel 1 includes a transparent portion 15 that allows light to pass through and an opaque portion 16 that does not allow the light to pass through. In the present embodiment, the display panel is lit by a light source that is disposed on a rear side 19 of the display panel 11. Thus, when the display panel 1 is viewed from a front side 18, the transparent portion 15 is illuminated by being lit by the light source.

The transparent portion 15 can be colored in a predetermined color by appropriately mixing UV curable inks having colors such as black, white, magenta, cyan, yellow, light-cyan, light-magenta, clear (transparent) and the like. In the present embodiment, the transparent portion 15 is formed by the transparent printed portion 22 that is made by using only clear UV curable ink. The transparent portion 15 indicates fuel indicator, direction indicator, scale of a speed meter, gear indicators and the like. The transparent portion 15 can be displayed brightly by the light of the light source provided on the rear side 19 of the display panel 1, even in a dark place. As another example, the transparent portion 15 can be provided by a color printed portion by adjusting the amount of ink and the like.

The opaque portion 16 is provided by the color printed portion 21, which is formed by using black UV curable ink.

In the present embodiment, the transparent printed portion 22 is also formed in an area corresponding to the transparent portion 15. Thus, the transparent portion 15 and the opaque portion 16 have the substantially same thickness. That is, the surface of the printed layer 2 is substantially smooth.

Further, an overcoat layer 3 is formed over an entire surface of the printed layer 2, on the front side 18 of the display panel 1. The overcoat layer 3 is formed so as to reduce gloss due to external light. For example, the overcoat layer 3 can be formed of a general transparent matting material. In the present embodiment, the overcoat layer 3 is formed by screen printing.

Next, a method of manufacturing the display panel 1 will be described. As shown in FIG. 3, the printed layer 2 is formed by jetting UV curable ink 75 to at least a portion of the base plate 11 and curing the deposited UV curable ink 75 by radiating UV light 75, using an inkjet printing device 7. The UV curable ink 75 contains UV monomer, which is polymerized by the UV light. Here, the printed layer 2 is formed by a step of forming a color printed portion and a step of forming a transparent printed portion.

In the color printed portion forming step, a color UV curable ink is deposited on the base plate 11. That is, the color printed portion 21 is formed by the color printed portion forming step. In the transparent printed portion forming step, a transparent UV curable ink is deposited in depressions 255 (255a) that are provided between the color printed portion 21 and the base plate 11, such as, provided between the color printed portions 21 on the surface of the base plate 11. Thus, the transparent printed portion 22 is formed by the transparent printed portion forming step. Also, the transparent UV curable ink is deposited in the depression 255 (255b) that are caused on the surface of the color printed portion 21. The transparent printed portion forming step can be performed after the color printed portion forming step. Further, the transparent printed portion forming step can be performed simultaneous with the color printed portion forming step. That is, the color printed portion 21 and the transparent printed portion 22 are formed by one inkjet printing.

In the present embodiment, data of a design image as shown in FIG. 1, is formed by a microcomputer, and the design image is printed on the base plate 11 by the inkjet printing using the UV curable ink based on the data.

To form the data of the design image, for example, an image processing software of Adobe Systems Inc. is used. Further, as the inkjet printing device 7, a UV curable inkjet printer with a UV radiation source, which is simultaneously driven, of UFJ 650 of MIMAKI ENGINEERING CO., LTD., is used. The printing is performed in a mode where the resolution is 1200×1200 DPI and the amount of dot droplet is 6 μl.

As shown in FIG. 3, the inkjet printing device 7 has an inkjet head unit 71 and a light source 72 for radiating the UV light. The light source 72 is disposed directly next to the inkjet head unit 71. After the drops of UV curable ink 75 is ejected from the nozzle of the inkjet head unit 71, an ultraviolet light 725 is radiated to the ejected ink. The inkjet head unit 71 at least includes a black UV curable inkjet head 711 and transparent UV curable inkjet head 712.

The design of image to be printed on the display panel 1 is made by the microcomputer, and the image data is inputted to the inkjet printing device 7. Also, the resolution of each of the printed portions 21, 22, the amount of droplet of ink, the cooler, the dot rate and the like are set.

Then, the UV curable ink is ejected to predetermined areas of the base plate 11 where the transparent portion 15 and the opaque portion 16 are to be formed, and the UV light 75 is radiated within one second after the ejection of the ink so as to cure the ink. In this case, the color UV curable ink (e.g., black) is deposited in layers in the area corresponding to the opaque portion 16, so that the cooler printed portion 21 is formed. Also, the transparent UV curable ink is deposited in layers in the area corresponding to the transparent portion 15, so that the transparent printed portion 22 is formed. Further, the color printed portion 21 and the transparent printed portion 22 are formed such that a height difference between them is equal to or less than 30 μm. As such, the printed layer 2 having the substantially smooth surface is formed on the base plate 11, as shown in FIG. 2A.

Then, as shown in FIG. 2B, the transparent overcoat layer 3 for matting is formed over the surface of the printed layer 2. The transparent overcoat layer 3 is formed entirely over the printed layer 2 by screen printing using a transparent UV curable ink and a screen of 250 mesh. The transparent curable ink is cured by radiation of the UV light. For example, DAT beads-contained clear ink of Teikoku Printing Inks. Mfg. Co., Ltd., is used as the transparent UV curable ink for the overcoat layer 3. As such, the display panel 1 as shown in FIG. 2B is formed.

The display panel 1 formed as above is housed in an instrument housing constructed of a housing body and a face plate, together with pointers, movements, light sources and the like. Accordingly, the instrument is produced.

In the present embodiment, the printed layer 2 is formed on the base plate 11 by performing the color print portion forming step and the transparent print portion forming step. In the color print portion forming step, the color UV curable ink is printed on the base plate 11. At this time, projections and/or depressions will be formed between a region where the color print portion 21 is formed and a region (255a) where the color print portion 21 is not formed, between a region where the thickness of the color print portion 21 is large and a region (255b) where the thickness of the color print portion 21 is small, and the like.

In the present embodiment, the transparent print portion 22 is formed by depositing the transparent UV curable ink in depressions 255 (255a, 255b), which is caused by the transparent print portion forming step. For example, in the transparent printed portion forming step, the transparent UV curable ink can be deposited in the depression 255 (255a) provided between the color printed portions 21 on the surface of the base plate 11, as shown in FIG. 2A. Further, the transparent UV curable ink can be deposited in the depressions 255 (255b), such as creases, provided between the ridges of the color printed portion 21 that is caused by the color printed portion forming step, as shown in FIG. 5A.

In the case where the transparent UV curable ink is deposited in the depressions 255 (255b) provided between the ridges of the color printed portion 21, a transparent UV curable ink 221 is deposited in the depressions 255 (255b) in a discontinuous or non-linear manner, as shown in FIG. 6A. Further, a transparent UV curable ink 222 can be deposited between the deposited transparent UV curable inks 221, as shown in FIG. 6B.

In the present embodiment, the transparent printed portion 22 is formed by depositing the depressions 255 that are caused in the color printed portion forming step. Therefore, unevenness of the surface of the printed layer 2 is reduced. That is, the printed layer 2 having the substantially smooth surface can be formed. Accordingly, even when the display panel 1 receives an external light diagonally, the projections and depressions of the surface of the display panel 1 is less visible. The display panel 1 achieves enhanced design and appearance.

The transparent printed portion 22 is formed such that the height difference between the color printed portion 21 and the transparent printed portion 22 is equal to or less than 30 μm. The overcoat layer 3 is formed over the printed layer 2 by screen printing. Therefore, in forming the overcoat layer 3, the ink is deposited equally over the printed layer 2. As such, the substantially uniform overcoat layer 3 is formed.

In the present embodiment, the transparent printed portion 22 of the transparent portion 15 is formed only by the transparent UV curable ink. However, the transparent printed portion 22 can be formed by a transparent ink 223 containing a color ink 224, as shown in FIG. 4

### Second Embodiment

In the second embodiment, the overcoat layer 3 for matting is formed in a nonlinear pattern by depositing a transparent UV curable ink in a discontinuous manner.

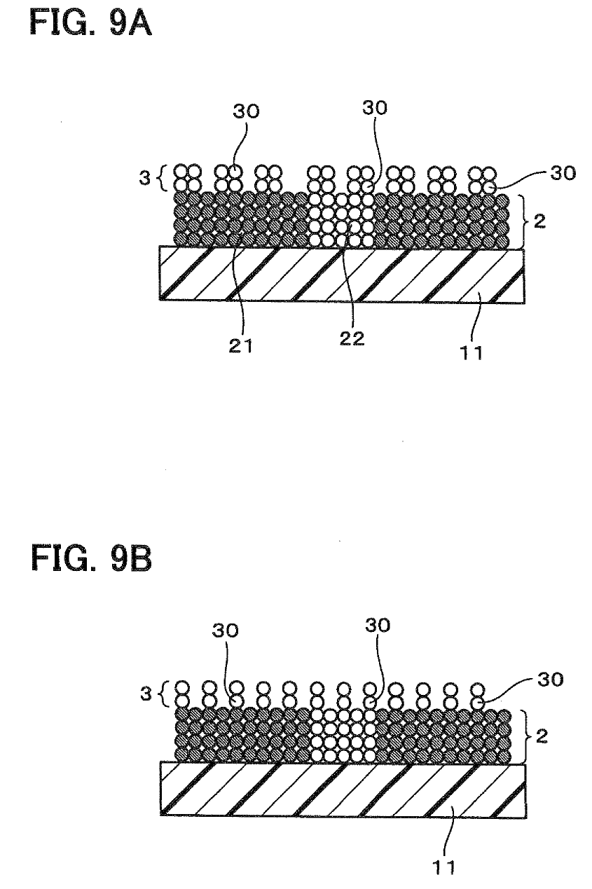

First, as shown in FIG. 9, the printed layer 2 including the color printed portion 21 and the transparent printed portion 22 is formed on the base plate 11 by inkjet printing using the UV curable ink. Similar to the first embodiment, the transparent printed portion 22 is formed such that the height difference between the transparent printed portion 22 and the color printed portion 21 is equal to or less than 30 μm.

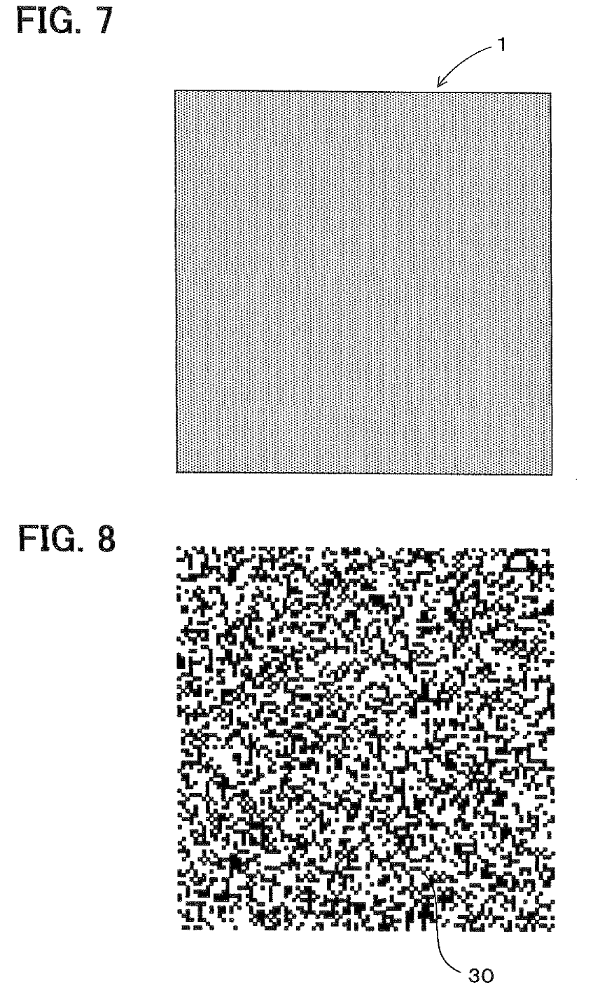

Then, the overcoat layer 3 is formed by depositing and curing the transparent UV curable ink over the printed layer 2 by inkjet printing. FIGS. 7 and 8 show a printing pattern of the overcoat layer 3.

That is, the transparent UV curable ink is deposited over the printed layer 2 in patterns in which ink particles 30 do not contact each other or less contact each other, as shown in FIGS. 9A and 9B, and is cured thereon. In this case, regular linear pattern of the printed layer 2 formed by inkjet printing can be disrupted or interrupted by the overcoat layer 3. That is, since interference of light is caused over the surface of the display panel 1, it is less likely that unevenness of the surface of the printed layer 2 will be emphasized. Also, gloss of the surface of the display panel 1 can be controlled.

Additional advantages and modifications will readily occur to those skilled in the art. The invention in its broader term is therefore not limited to the specific details, representative apparatus, and illustrative examples shown and described.

### COMPARATIVE EXAMPLE

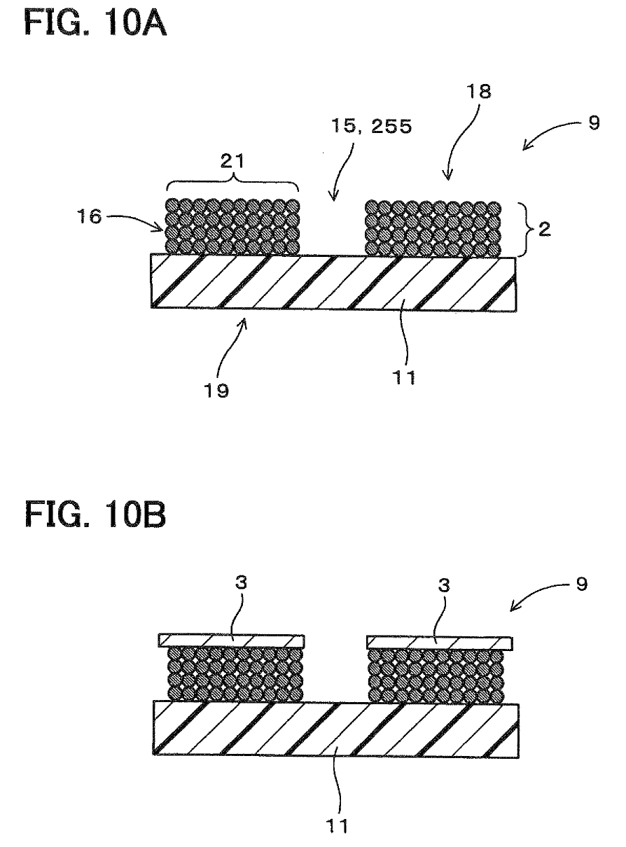

As a comparative example, a display panel 9 is formed in the similar manner as that of the first embodiment as shown in FIGS. 10A and 10B. However, the transparent printed portion is not formed in the display panel 9.

First, the base plate 11 is prepared. The drops of the cooler UV curable ink (e.g., black) is ejected to an area corresponding to the opaque portion 16 and the ultraviolet light is radiated within one second from the ejection of the jet of the ink to cure the deposited ink. As such, the color printed portion 21 is formed on the base plate 11, as shown in FIG. 10A.

The color printed portion 21 is formed by depositing the UV curable ink in layers. Thus, the opaque portion 16 that does not allow a visible-light to pass through is formed. On the other hand, the transparent UV curable ink is not disposed in an area corresponding to the transparent portion 15. That is, the transparent portion 15 is provided by the area on which the transparent UV curable ink is not deposited. In this case, therefore, the printed layer 2 formed on the base plate 11 have a large height difference between the transparent portion 15 and the opaque portion 16.

Then, as shown in FIG. 10B, the overcoat layer 3 for matting is formed over the printed layer 2. In this case, the overcoat layer 3 is formed by screen printing, similar to the first embodiment.

In the comparative example, the transparent printed portion is not formed in the transparent portion 15. Therefore, the ink does not sufficiently enter the area corresponding to the transparent portion 15, that is, the depressions 255. Accordingly, the gloss of the surface of the display panel 9 has unevenness. Since the thickness of the printed layer 2 is greatly different between the transparent portion 15 and the opaque portion 16, the projection and depression of the surface of the printed layer 2 is conspicuously visible, particular, when the external light is emitted diagonally to the surface of the display panel 9.

What is claimed is:

1. A method of manufacturing a display panel including a resinous base and a printed layer printed on a surface of the resinous base by inkjet printing using UV curable ink, the UV curable ink containing UV monomer capable of being cured by polymerization by radiation of a UV light, the printed layer including a color printed portion and a transparent printed portion, the method comprising:
forming the color printed portion by depositing color UV curable ink on a predetermined portion of the base; and
forming the transparent printed portion by depositing a transparent UV curable ink in at least one of a first depression provided by the color printed portion on the surface of the base and a second depression provided on a surface of the color printed portion.

2. The method according to claim 1, wherein
in the forming of the transparent printed portion, the transparent printed portion is formed such that a height difference between the transparent printed portion and the color printed portion is equal to or less than 30 μm.

3. The method according to claim 1, further comprising forming a transparent overcoat layer over the printed layer.

4. The method according to claim 3, wherein the forming of the transparent overcoat layer is performed by screen printing.

5. The method according to claim 3, wherein the forming of the transparent overcoat layer is performed by inkjet printing, and in which a transparent UV curable ink is deposited on the printed layer in a discontinuous manner.

6. The method according to claim 1, wherein
the forming of the color printed portion and the forming of the transparent printed portion are performed simultaneously.

7. The method according to claim 1, wherein
the forming of the transparent printed portion includes depositing the transparent UV curable ink in a nonlinear manner.

8. The method according to claim 7, wherein
the second depression is provided by creases formed on the surface of the color printed portion, and
in the depositing of the transparent UV curable ink in the nonlinear manner, the transparent UV curable ink is deposited along the creases.

9. The method according to claim 1, wherein
the transparent printed portion deposited in the first depression forms a transparent portion of the display panel, and the color printed portion forms an opaque background section of the display panel.
